(19) United States
(12) Patent Application Publication
(10) Pub. No.: US 2009/0115878 A1
(43) Pub. Date: May 7, 2009

(54) Method, system and apparatus to boost pixel floating diffusion node voltage

(75) Inventor: Richard A. Mauritzson, Meridian, ID (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/979,719

(22) Filed: Nov. 7, 2007

(51) Int. Cl. H04N 5/335

(52) U.S. Cl. 348/307; 348/E05.091

(57) ABSTRACT

A method, apparatus and system providing a pixel within an imaging device in which a separate power source is used for resetting a floating diffusion node from a power source used for pixel operating power.

### FIELD OF THE INVENTION

The invention relates generally to imager devices, and more particularly to resetting pixels having a floating diffusion node.

### BACKGROUND OF THE INVENTION

An imager, for example, a complementary metal oxide semiconductor (CMOS) imager, includes a focal plane array of pixels. FIG. 1 shows an example of a pixel commonly used in such an imager. FIG. 1 shows a four transistor pixel. Each pixel 10 includes a photo-conversion device 20, for example, a photogate, photoconductor or a photodiode overlying a substrate for producing a photo-generated charge in a doped region of the substrate. A readout circuit is provided for each pixel and includes at least a source-follower transistor 30 and a row select transistor 40, the latter controlled by a signal RS, for coupling the source-follower transistor 30 to a column output line 50. The four transistor pixel 10 also typically has a floating diffusion node 60, connected to the gate of the source-follower transistor 30. Charge accumulated by the photo-conversion device 20 is first stored in the photo-conversion device 20 during an integration period and later transferred to a storage region, i.e., floating diffusion node 60. The four transistor pixel 10 also includes a transfer transistor 70, controlled by a signal TX, for transferring charge from the photo-conversion device to the floating diffusion node 60 and a reset transistor 80, controlled by a signal RST, for resetting the floating diffusion node 60 to a predetermined charge level. The reset transistor 80 and source-follower transistor 30 are both powered by voltage source Vaa, a global supply voltage provided to all pixels in the array.

Other CMOS imager pixel architectures employing three, or five or more transistors are also known, but all have a photo-conversion device 20, floating diffusion region 60, reset transistor 80, and source follows transistor 30. A three transistor pixel can omit the transfer transistor 70 or row select transistor 40, while pixel architectures employing five or more transistors add transistors and additional operational features to the FIG. 1 pixel circuit.

FIG. 2 illustrates a block diagram of a CMOS imager device 208 having a pixel array 200 which may employ the four transistor pixels with reference to FIG. 1 or other known pixel circuits constructed as described above. Pixel array 200 comprises a plurality of pixels 10 arranged in a predetermined number of columns and rows. The pixels of each row in array 200 are all turned on at the same time by a row select lines, and the pixel signals of each column are selectively output by respective column select lines. A plurality of row and column select lines are provided for the entire array 200. The row select lines are selectively activated in sequence by the row driver 210 in response to row address decoder 220 and the column select lines are selectively activated in sequence or in parallel for each row activated by the column driver 260 in response to column address decoder 270. Thus, a row and column address is provided for each pixel. The CMOS imager 208 is operated by the control circuit 250, which controls address decoders 220, 270 for selecting the appropriate row and column lines for pixel readout, and row and column driver circuitry 210, 260, which apply driving voltage to the drive transistors of the selected row and column select lines.

During a pixel readout, the pixel output signals typically include a pixel reset signal, Vrst, taken off the floating diffusion node 60 when it is reset and a pixel image signal, Vsig, which is taken off the floating diffusion node after charges generated at photo-conversion device 20 are transferred to it. The Vrst and Vsig signals are read by a sample and hold circuit 265 and are subtracted by a differential amplifier 267 that produces a signal (e.g., Vrst−Vsig) for each pixel, which represents the amount of light photons impinging on the pixels. This difference signal is digitized by an analog to digital converter 275. The digitized pixel signals are then fed to an image processor 280 to form a digital image. The digitizing and image processing can be performed on or off the chip containing the pixel array.

Referring back to FIG. 1, in a known CMOS pixel circuit the reset transistor 80 and the source-follower transistor 30 are both powered by voltage source Vaa. Vaa is typically maintained at a constant voltage (for example, 2.8V) during the integration period when an image is captured and during the readout of pixel output signals Vrst, Vsig. Vaa provides power for drain of the the source-follower 30 transistor and provides a reset voltage level for the floating diffusion node 60 when reset by the reset transistor 80. The output signal level of a pixel is often limited by the full well capacity of the floating diffusion node 60. In order to increase the floating diffusion node 60 full well capacity, it would be preferable to boost Vaa to a higher voltage level. An increased floating diffusion node 60 full well capacity provided by the boosted Vaa could result in an improved signal-to-noise ratio, improved voltage swing on the floating diffusion node 60 for a given conversion gain, and reduced charge transfer lag due to a higher bias across the transfer transistor 70 gate.

Various problems may arise when attempting to boost Vaa beyond an external supply voltage. For example, when the source-follower transistor 30 is turned on during readout of a pixel signal from the floating diffusion region 60, and the row is selected for readout (by turning on row-select transistor 40), the boosted voltage source Vaa is drained by a current flow passing through the source-follower transistor 30, the row-select transistor 40 and on through the column output line 50. Due to this drain, a boosted Vaa would require an increased amount of power to drive the pixel 10 during pixel readout, which may be difficult to sustain. In addition, capacitance associated with the Vaa node would increase along with the increased voltage level, making it difficult to raise Vaa above the external voltage level.

An improved method and apparatus for increasing the full well capacity of the floating diffusion region would be desirable.

### BRIEF DESCRIPTION OF THE DRAWINGS

FIG. 1 an electrical schematic of a conventional four-transistor pixel.

FIG. 2 is a block diagram of a conventional imager device.

FIG. 3 an electrical schematic of a first embodiment of a pixel.

FIG. 3A is an electrical schematic of a portion of FIG. 3 showing a modification thereto.

FIG. 4 is a timing diagram of an integration and read out operation of the pixel shown FIG. 3.

FIG. 5 is an electrical schematic of a second embodiment of a pixel.

FIG. 6 is a timing diagram of an integration and read out operation of the pixel shown in FIG. 5.

FIG. 7 is a block diagram of a processor system incorporating at least one pixel constructed in accordance with an embodiment described herein.

### DETAILED DESCRIPTION OF THE INVENTION

In the following detailed description, reference is made to the accompanying drawings which form a part hereof, and which illustrate specific embodiments. These embodiments are described in sufficient detail to enable those of ordinary skill in the art to make and use them. It is also understood that structural, logical, or procedural changes may be made to the specific embodiments disclosed herein.

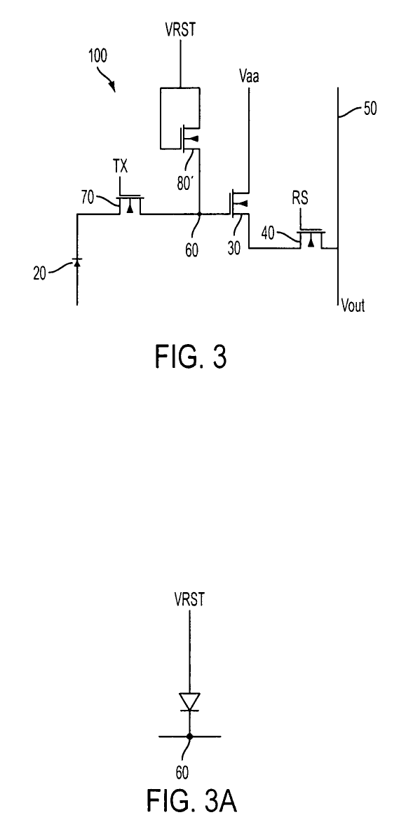

Referring to FIG. 3, a first embodiment of a four-transistor pixel 100 capable of boosting a voltage level on the floating diffusion node 60 is illustrated. In this embodiment, the reset transistor 80′ is powered and controlled by a signal VRST that is separate from voltage source Vaa. VRST may therefore be set to a level potentially less than, equal to or preferably higher than Vaa during operation of the reset transistor 80′. As a result, the voltage applied to the floating diffusion region is separate and apart from the Vaa source voltage. When VRST is set higher than Vaa (typically greater than Vaa plus the threshold voltage of reset transistor 80), the reset voltage applied to the floating diffusion node 60 can increase the full well capacity of the floating diffusion node 60 over that which can be obtained when Vaa is used as the source for the reset voltage (charge capacity is directly related to Q=CV). In addition, since the signal VRST is separate from Vaa and is a pulsed signal, as described below, a lower overall power consumption is obtained compared with resetting the floating diffusion node 60 with a boosted Vaa voltage. Also, the VRST voltage level can be set to different values, depending on the reset operation needed, as also described below.

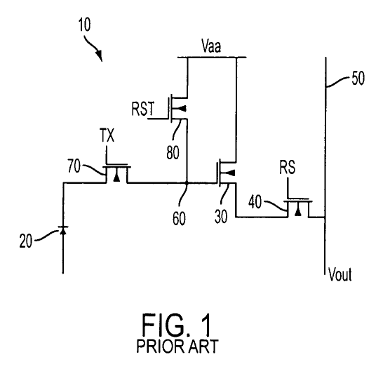

Other than the circuit configuration required to use VRST as both the operating voltage and the control signal for the reset transistor 80′, pixel 100 functions essentially the same as pixel 10 (FIG. 1). The photo-conversion device 20, transfer transistor 70, floating diffusion node 60, source-follower transistor 30, row-select transistor 40 and column output line 50 elements of pixel 100 each function in the same manner as described above for pixel 10.

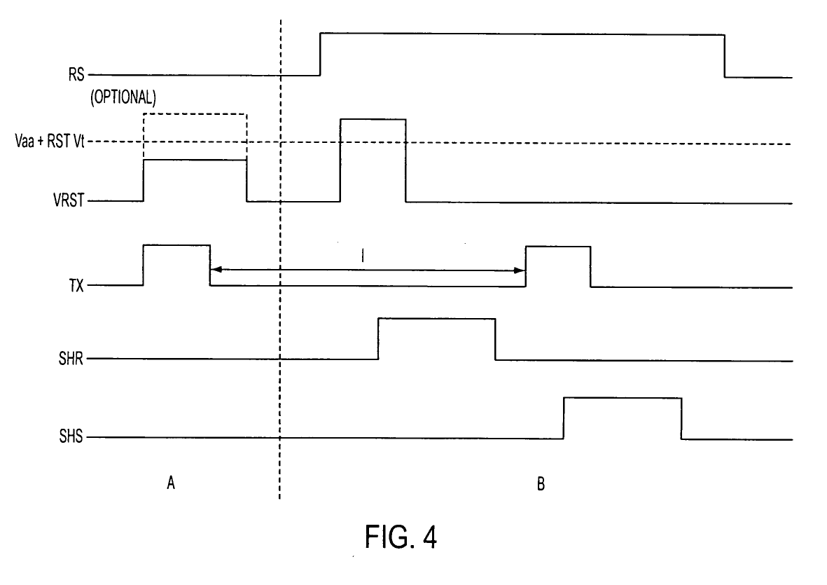

FIG. 4 shows a timing diagram of reset, integration and readout operations of pixel 100 and includes a threshold voltage level Vt for reset transistor 80′. It should be understood that the timing diagram shown in FIG. 4 is only one way of operating pixel 100 and should not be viewed as limiting.

A pixel reset operation where the photo-conversion device 20 is reset is executed on side “A” of the timing diagram, a readout operation, which includes a reset of floating diffusion node 60, is executed on side “B” of the timing diagram and charge integration by the photo-conversion device 20 occurs between the two TX pulses during the time period labeled “I”. The reset may be executed in substantially the same manner as a conventional reset of pixel 10. VRST is pulsed above Vaa plus the reset transistor 80′ threshold voltage Vt simultaneously with a TX pulse to the transfer transistor 70. The photo-conversion device 20 is typically reset to its pinned potential (assuming a pinned photodiode structure), and the floating diffusion node 60 is reset to VRST minus the threshold voltage of the reset transistor 80. After TX returns low, the transfer transistor 70 turns off and the integration period (“I”) begins for the photo-conversion device 20. VRST may return low simultaneously with TX or may be held high for a short amount of time after TX has dropped in order to ensure a clear path free for electrons passing from photo-conversion device 20 to the floating diffusion node 60.

While the photo-conversion device 20 is accumulating charge from the image to be captured during the integration period (“I”), a row-select signal RS is set high to select a row for readout of a pixel output signal. After the row has been selected for readout, reset signal VRST is again pulsed to a boosted voltage level to reset the floating diffusion node 60 to a voltage level greater than the operating voltage Vaa. The boosted reset level can be higher than the level of the VRST used to reset the photo-conversion device 20 during the reset operation shown in side A of FIG. 4. The boosted reset level is possible due to the separation of the VRST and Vaa signal lines. As an example, assuming a reset transistor 80′ threshold voltage of 0.7V and Vaa of 2.8V, in order to achieve a floating diffusion node 60 reset of +0.5V over Vaa, for example, VRST should be pulsed to, e.g., 4V. The floating diffusion node 60 voltage would thereby be boosted to about 3.3V (3.3V=4V−0.7V=2.8V+0.5V). Accordingly, the floating diffusion node 60 is reset in a manner providing it with a greater full well capacity than is possible using Vaa as the reset voltage (charge of the floating diffusion node 60=C×V). In addition, problems associated with globally boosting Vaa for reset are avoided.

The VRST is illustrated in FIG. 4 in the reset “A” and readout “B” operating nodes as returning to a low state. The low state of VRST may be a voltage ground, but also may be a low positive voltage of less than 0.3 volts to operate the reset transistor 80′ for the purpose of providing some anti-blooming leakage for the floating diffusion node 60. If the control signal TX for transfer transistor 70 is likewise slightly positive during the integration period I anti-blooming can also be provided for the photo-conversion device 20.

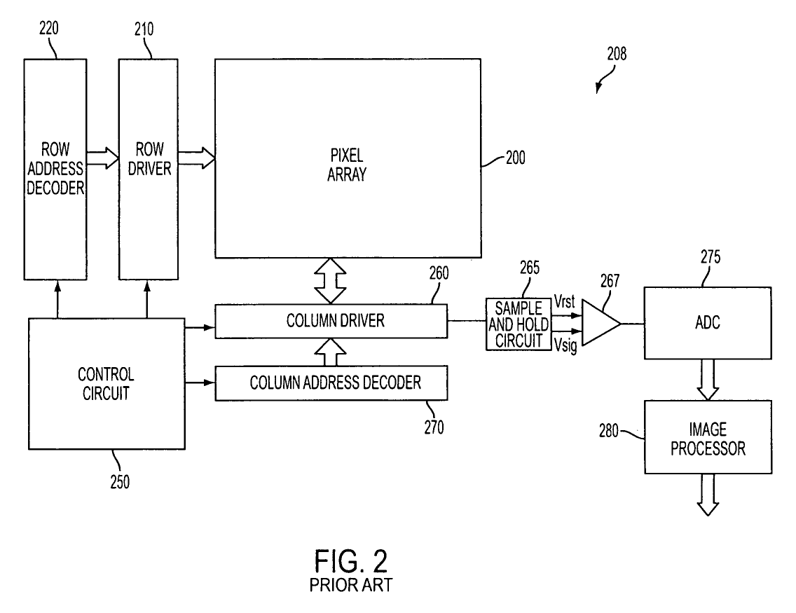

After the floating diffusion node 60 has been reset on side B of the FIG.4 timing diagram, a readout of the pixel output signal may be initiated, for example, by using a conventional correlated double sampling readout. A first sample-and-hold signal SHR is pulsed to sample the boosted reset-level charge on the floating diffusion node 60 (i.e., Vrst). The transfer transistor 70 control signal TX is then pulsed on to transfer accumulated charge from the photo-conversion device 20 to the floating diffusion node 60, thus ending the integration period (“I”). The boosted voltage on the floating diffusion node 60 may improve the rate and efficiency of the transfer of charge from the photo-conversion device 20 due to the higher bias across the transfer transistor 70 gate. The transferred charge, which represents the pixel output and is now stored in the floating diffusion node 60, is sampled as Vsig by pulsing a second sample-and-hold signal SHS. The two signal samples Vrst, Vsig are processed by readout processing circuitry outside of pixel 100 as previously described with reference to imaging device 208. Accordingly, an improved full well capacity of the floating diffusion node 60 may be utilized for the pixels in pixel array 200 (FIG. 2).

Although FIG. 3 illustrates a reset device as a reset transistor 80′, having a commonly connected source/drain in terminal and gate terminal, for resetting the floating diffusion node 60, reset transistor 80′ may also be replaced by a diode connected between floating diffusion node 60 and a line supplying the Vrst voltage as shown in FIG. 3A.

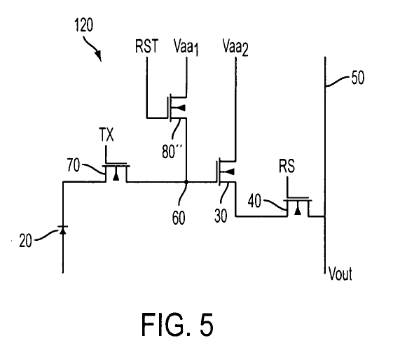

FIG. 5 shows another embodiment of a pixel 120 including separate operating voltage sources Vaa1, Vaa2 for the reset transistor 80″ and the source-follower transistor 30, respectively. In this embodiment, the reset voltage level of the floating diffusion node 60 is set by voltage source Vaa1 which is independent of the voltage source Vaa2 that provides power for the source-follower transistor 30. In this embodiment the reset control signal RST turns on reset transistor 80″.

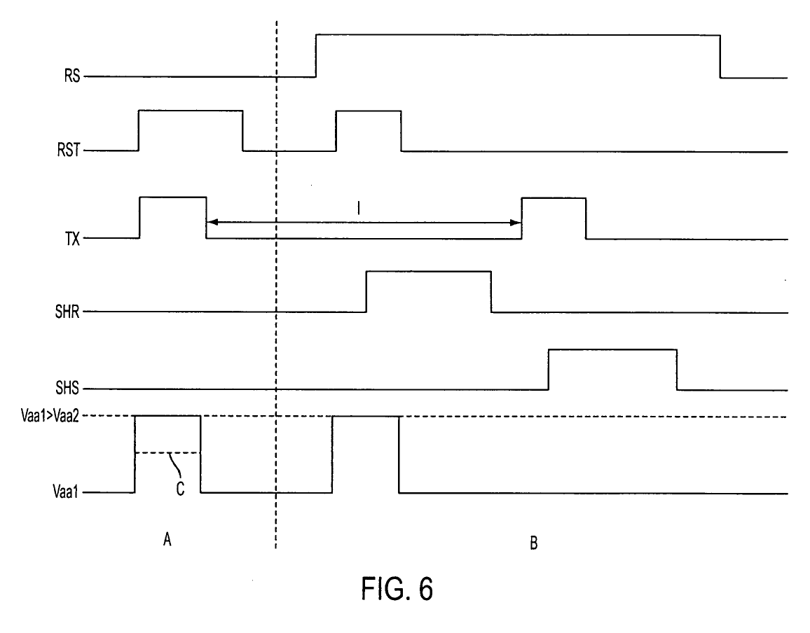

FIG. 6 shows a timing diagram of reset, integration and readout operations of pixel 100. It should be understood that the timing diagram shown in FIG. 6 is only one way of operating pixel 120 and should not be viewed as limiting. In FIG. 6 the reset control signal RST moves between two voltage levels, but the Vaa1 voltage applied to reset the floating diffusion node 60 is a pulsed signal. In this timing diagram, operations are executed similar to the operation of pixel 100 as described above. In side A of the FIG. 6 timing diagram the photo-conversion device 20 and floating diffusion node 60 are reset as described above with respect to FIGS. 3 and 4, with addition of a pulsed Vaa1 to supply the reset operating voltage. On the side B, however, Vaa1 is boosted high simultaneously with the pulse of the RST control signal applied to the gate of reset transistor 80″ during the integration period (“I”). Accordingly, the floating diffusion node 60 is reset with the Vaa voltage, which is set at a level higher than that of Vaa2 providing floating diffusion node 60 with an increased full well capacity over that which could be obtained if Vaa were used as the reset voltage. It should be noted that, as indicated by the dotted line C in FIG. 6, when Vaa1 is used in region A to reset the photo-conversion device 20, it can be at a lower level than that used in region B to reset floating diffusion region 60.

As noted above, the reset transistor 80″ may be operated for anti-blooming of the floating diffusion node 60 such that when the RST signal is pulsed low it may be pulsed to a low positive voltage level of less than 0.3 volts instead of ground potential.

It should be appreciated that while pixel embodiments described herein employ four transistors, this in merely exemplary, as the floating diffusion node and reset circuits described herein may be applied to pixel architecture having fewer or more than four transistors.

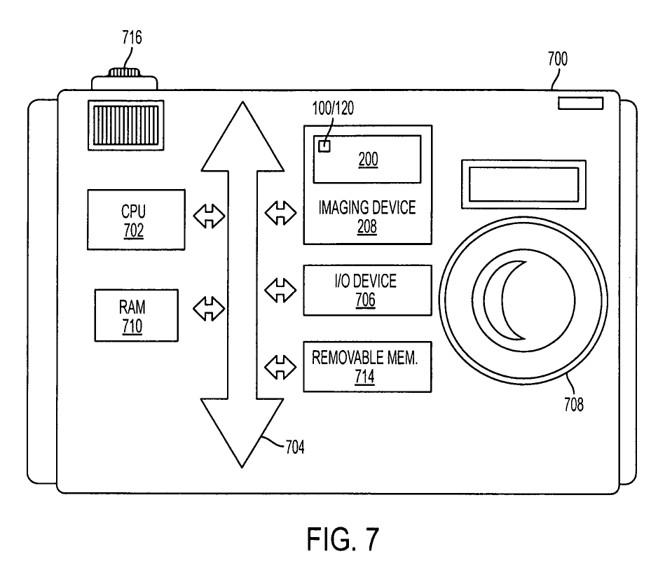

FIG. 7 shows an image processor system 700, for example, a still or video digital camera system, which includes an imaging device 208 (FIG. 2) having a pixel array 200 employing pixels 100 (or pixel 120) constructed in accordance with embodiments described herein. The imaging device 208 may receive control or other data from system 700. The imaging device 208 receives light on pixel array 200 thru the lens 708 when shutter release button 716 is pressed. System 700 includes a processor 702 having a central processing unit (CPU) that communicates with various devices over a bus 704, including with imager device 208. Some of the devices connected to the bus 704 provide communication into and out of the system 700, such as one or more input/output (I/O) devices 706 which may include input setting and display circuits. Other devices connected to the bus 704 provide memory, illustratively including a random access memory (RAM) 710, and one or more peripheral memory devices such as a removable, e.g., flash, memory drive 714. The imager device 208 may be constructed as shown in FIG. 2 with the pixel array 200 having pixels 100/120 and the variations as described herein. The imager device 208 may, in turn, be coupled to processor 702 for image processing, or other image handling operations. Examples of processor based systems, which may employ the imager device 208, include, without limitation, computer systems, camera systems, scanners, machine vision systems, vehicle navigation systems, video telephones, surveillance systems, auto focus systems, star tracker systems, motion detection systems, image stabilization systems, and others.

While embodiments have been described in detail, it should be readily understood that the invention is not limited to the disclosed embodiments. Rather the embodiments can be modified to incorporate any number of variations, alterations, substitutions or equivalent arrangements not heretofore described. Accordingly, the invention is not limited by the foregoing description but is only limited by the scope of the attached claims.

What is claimed as new and desired to be protected by Letters Patent of the United States is:

1. A pixel circuit, comprising:
photo-conversion device for accumulating charge;
a storage region for storing charge accumulated by the photo-conversion device;
a transistor for outputting a signal based on the stored charge, the transistor receiving a first operating voltage;
a device for resetting the storage region by applying a voltage to the storage region, the device receiving a second operating voltage that is higher than the first operating voltage.

2. The pixel circuit of claim 1, wherein the first operating voltage is supplied on a first voltage source line and the second operating voltage is supplied on a second voltage source line.

3. The pixel circuit of claim 2, wherein the device comprises a reset transistor which has a gate and a source/device terminal coupled to the second voltage source line.

4. The pixel circuit of claim 1 wherein the device comprises a diode.

5. The pixel circuit of claim 2 where the device comprises a reset transistor having a first source/drain terminal coupled to the second voltage source line, a second source/drain terminal coupled to the storage region, and a gate for receiving a reset control signal.

6. The pixel circuit of claim 5, further comprising a third transistor for controlling a transfer of charge from the photo-conversion device to the storage region, having a first drain/source connected to the photo-conversion device and a second drain/source connected to the storage region.

7. The pixel circuit of claim 6, further comprising a fourth transistor for selecting the pixel circuit for output, having a first source/drain connected to a source/drain of the second transistor and a second source/drain connected to an output line.

8. The pixel circuit of claim 2, wherein the device for resetting also resets the photo-conversion device, the second voltage source line supplying a first pulsed voltage for resetting the photo-conversion device and a second pulsed voltage for resetting the storage region.

9. The pixel circuit of claim 8, wherein the second pulse voltage is higher than the first pulsed voltage.

10. The pixel circuit of claim 8, further comprising a transfer transistor activated by a control signal for transferring charge from the photo-conversion device to the storage region, the transfer transistor being activated by the control signal during a time when the first pulsed voltage is supplied by the second voltage source line.

11. The pixel circuit of claim 10, wherein the second voltage source line supplies the first voltage pulse signal for some time after the control signal no longer activates the transfer transistor.

12. The pixel circuit of claim 1, wherein the pixel circuit is part of a pixel array of an imager device.

13. The pixel circuit of claim 12, wherein the imager device is part of a digital camera.

14. A method of operating a pixel circuit, the method comprising:
supplying a first voltage from a first voltage source as a reset voltage to a floating diffusion node of the pixel; and
supplying a second voltage from a second voltage source as an operating voltage to a readout circuit of the pixel.

15. A method as in claim 14, wherein the first voltage is of a higher voltage level than the second voltage.

16. A method as in claim 14 further comprising supplying the reset voltage to the floating diffusion node through a reset device.

17. A method as in claim 14, wherein the reset device is a reset transistor having one source/device terminal connected to the floating diffusion node and the first voltage is supplied to a second source/drain terminal of the reset transistor.

18. A method is in claim 17 further comprising supplying the voltage to a gate of the reset transistor.

19. A method as in claim 17 further comprising controlling operation of the reset transistor with a reset control signal support to its gate.

20. A method as in claim 14 wherein the pixel circuit further comprises a photo-conversion device and the supplying of the first voltage comprises supplying the first voltage as a first voltage pulse of a first level to reset the photo-conversion device and the floating diffusion node and supplying the first voltage as a second voltage pulse of a second level, to reset the floating diffusion node.

21. A method as in claim 20 wherein the second level is greater than the first level.

22. A method of claim 21, wherein the pixel circuit further comprises a transfer transistor for transferring charge from the photo-conversion device and the floating diffusion node and the first voltage pulse is supplied during a period when the transfer transistor is on.

23. A method of claim 17 further comprising operating the reset transistor in an anti-blooming mode when the reset transistor is not resetting the floating diffusion region.

24. A method of operating a pixel circuit, the method comprising:
providing an operating voltage for a first readout transistor from a first voltage source; and
resetting a floating diffusion node which is coupled to a gate of the readout transistor by pulsing a reset signal to a gate of a reset transistor from a second voltage source, where the reset signal is applied to both the gate and a drain/source terminal of the reset transistor and has a voltage level which is higher than that of the operating voltage.

25. The method of claim 24, wherein the reset signal is greater than the threshold voltage level of the reset transistor.

26. A method of operating a pixel circuit, the method comprising:
providing an operating voltage to a source-follower transistor from a first voltage source;
providing a reset voltage level to a reset transistor from a second voltage source having a voltage level higher than that of the operating voltage; and
resetting a floating diffusion voltage by pulsing a signal to a gate of a reset transistor from a third voltage source.

27. An imaging device, comprising:
a pixel array, wherein at least one pixel of the pixel array comprises:
a photo-conversion device for accumulating charge;
a storage region for storing charge accumulated by the photo-conversion device;
a first transistor for resetting the storage region charge level, the first transistor having a first source/drain connected to the storage region and a second source/drain connected to a gate of the first transistor and to a first voltage source;
a second transistor for outputting a signal based on the charge stored in the storage region, the second transistor having a gate connected to the storage region and a source/drain connected to a second voltage source, the voltage level supplied by the first voltage source being higher than that supplied by the second voltage source; and
a third transistor for selectively coupling the output of the second transistor to a column line.

28. The imaging device of claim 27, further comprising a fourth transistor for controlling a transfer of charge from the photo-conversion device to the storage region.

29. The imaging device of claim 27, wherein the first voltage source is not a boosted version of the voltage supplied by the second voltage source.
